(19) United States
(12) Patent Application Publication
(10) Pub. No.: US 2023/0246372 A1
(43) Pub. Date: Aug. 3, 2023

(54) MULTI-POSITION CHANGE-OVER DEVICE AND A MULTI-SIDE SOCKET WITH IT

(71) Applicants: Liang Guan LIN, Guangdong (CN); Xiao Long LI, Guangdong (CN); Lei HU, Guangdong (CN); Junwen XIONG, Guangdong (CN)

(72) Inventors: Liang Guan LIN, Guangdong (CN); Xiao Long LI, Guangdong (CN); Lei HU, Guangdong (CN); Junwen XIONG, Guangdong (CN)

(21) Appl. No.: 18/101,581

(22) Filed: Jan. 26, 2023

(30) Foreign Application Priority Data
Jan. 29, 2022 (CN) 202220245486.5

(51) Int. Cl. H01R 13/24; H01R 13/46; H01R 13/187

(52) U.S. Cl. CPC H01R 13/2471; H01R 13/465; H01R 13/187

(57) ABSTRACT

The present utility model discloses a multi-position change-over device and a multi-side socket with it, wherein each of at least three sides of a core frame is arranged with a first slot and a second slot which are paired; meanwhile, the first slots located on two adjacent sides are intersected to form the first mounting grooves used for installing a first conducting sheet and the second slots located on two adjacent sides are intersected to form the second mounting grooves used for installing a second conducting sheet so that the first slots located on two adjacent sides share one first conducting sheet and the second slots located on two adjacent sides share one second conducting sheet in order to make the core frame smaller, save the consumption of the first conducting sheet and the second conducting sheet and improve the assembly efficiency and thus make the whole multi-side socket smaller, more exquisite, easier to carry and cost-lower.

### BACKGROUND OF THE INVENTION

The present utility model relates to the technical field of power sockets, in particular relates to a multi-position change-over device and a multi-side socket with it.

To enable a power socket to be inserted simultaneously with the plugs of a plurality of electronic products and occupy less space, any of the existing multi-side sockets is provided with insertion positions on a plurality of sides of the housing of such multi-side socket (such as the top, left and right sides of the housing) to arrange the pins of plugs of electronic products respectively.

Any of the existing multi-side sockets generally comprises a housing and a multi-position change-over device, wherein at least three of the upper, lower, left, right and front sides of the housing are with jack panels, each jack panel is arranged with at least one jack group (each jack group comprises two or three jacks for inserting a two or three-pin plug); the multi-position change-over device comprises a plurality of core frames and a plurality of conducting sheets, each core frame is arranged with mounting grooves corresponding to the jack groups on the jack panels, and the conducting sheets are embedded into the corresponding mounting grooves; when such multi-side socket is used, the pins of the plugs of electronic and electrical products are inserted into the corresponding mounting grooves and come into contact with the corresponding connecting sheets to conduct the circuit.

The existing multi-side sockets can be inserted with a plurality of plugs at the same time without taking up too much space; however, there is still shortcomings because any of the existing multi-side sockets is generally arranged with a plurality of mutually independent core frames in the housing as per the number of jack panels, arranged with mounting grooves and corresponding conducting sheets on the sides of each core frame opposite to the jack panes; such way of arranging a plurality of core frames and installing a plurality of conducting sheets, on the one hand, is characterized by big product sizes, complicated assembly and high production cost, on the other hand increases the number of wiring positions, causes disordered arrangement of wires in the multi-side sockets and thus causes potential safety hazards.

### BRIEF SUMMARY OF THE INVENTION

The main purpose of the present utility model is to provide a multi-position change-over device and a multi-side socket with it, aiming to reduce the volume of the multi-side socket, improve the assembly efficiency and increase the use safety.

In order to achieve the above purpose, the present utility model provides a multi-position change-over device comprising a plurality of core frames, wherein each of at least three sides of the said core frame are arranged with a first slot and a second slot which are paired, the first slots located on two adjacent sides are intersected to form the first mounting groove and inside each first mounting groove is installed with a first conducting sheet and the said first conducting sheet is provided with a first conducting part located in the first slot; the second slots located on two adjacent are intersected to form the second mounting groove and inside each second mounting groove is installed with a second conducting sheet and the said second conducting sheet is provided with a second conducting part located in the second slot.

The present utility model also provides a multi-side socket comprising a housing and a multi-position change-over device, wherein the multi-position change-over device is the multi-position change-over device described above and the said housing is arranged with corresponding pin apertures.

In the present utility model, each of at least three sides of a core frame are arranged with a first mounting groove and a second mounting groove which are paired; meanwhile, the first slots located on two adjacent sides of the core frame are intersected to form the first mounting grooves used for installing a first conducting sheet and the second slots located on two adjacent sides of the core frame are intersected to form the second mounting grooves used for installing a second conducting sheet so that the first slots located on two adjacent sides share a first conducting sheet and the second slots located on two adjacent sides share a second conducting sheet in order to make the core frame smaller, save the consumption of the first conducting sheet and the second conducting sheet and improve the assembly efficiency and thus make the whole multi-side socket smaller, more exquisite, easier to carry and cost-lower. In addition, in the present utility model, the sharing design of the core frame and the conducting sheets reduces the number of the wiring positions, simplifies the internal wiring of the multi-side socket and improve the use safety of the multi-side socket.

### BRIEF DESCRIPTION OF THE DRAWINGS

FIG. 1 is a schematic three-dimensional view I of a multi-position change-over device of the present utility model;

FIG. 2 is a schematic three-dimensional view II of a multi-position change-over device of the present utility model;

FIG. 3 is a schematic exploded view of a multi-position change-over device of the present utility model;

FIG. 4 is a schematic assembly diagram of the multi-position change-over device, the protective frame and the power cord and so on of the present utility model;

FIG. 5 is a schematic exploded diagram of the multi-position change-over device, the protective frame and the power cord and so on of the present utility model.

### DETAILED DESCRIPTION OF THE INVENTION

The technical solutions of the present utility model will be described more clearly and fully in conjunction with the accompanying drawings of the present utility model, and obviously, the described embodiments are merely a part of the embodiments of the present utility model, not all the embodiments. Based on the embodiments of the present utility model, all the other embodiments obtained by the ordinary skilled in the art without creative labors belong to the scope claimed by the present utility model.

It should be noted that if an embodiment of the present utility model relates to directive instructions (such as upper, lower, left, right, front, rear, top, bottom, inside, outside, vertical, transverse, longitudinal, counter-clockwise, clockwise, circumferential, radial and axial), these directive instructions are merely used to explain the relative position relationship, the movement and so on among the components at certain specific posture (as shown in the accompanying drawings); if the specific posture changes, the directive instructions should be changed accordingly.

In addition, if an embodiment of the present utility model relates to the descriptions such as “first” and “second”, these descriptions are merely used for description and should not be understood to indicate or imply their relative importance or implicitly indicate the number of the corresponding technical features. This shows that the features limited with “first” and “second” can explicitly or implicitly include one such feature at least. Moreover, the technical solutions among the embodiments can be in combination with each other; however, such combination must be on the premise that those skilled in the art can realize the related technical solutions; when the technical solutions are inconsistent or cannot be realized, such combination of technical solutions should be deemed to be inexistent and not in the scope claimed by the present utility model.

The present utility model provides a multi-position conversion device.

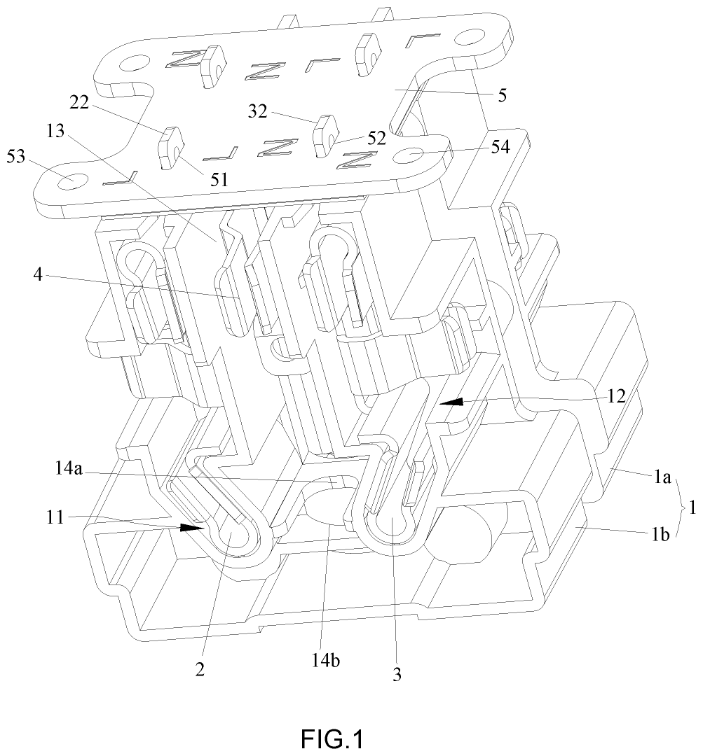

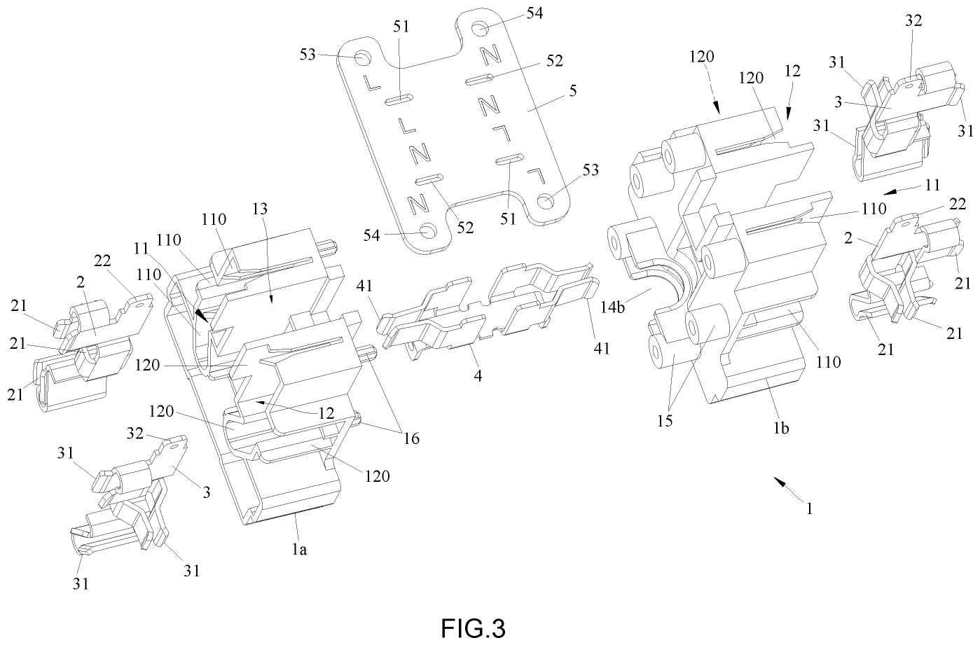

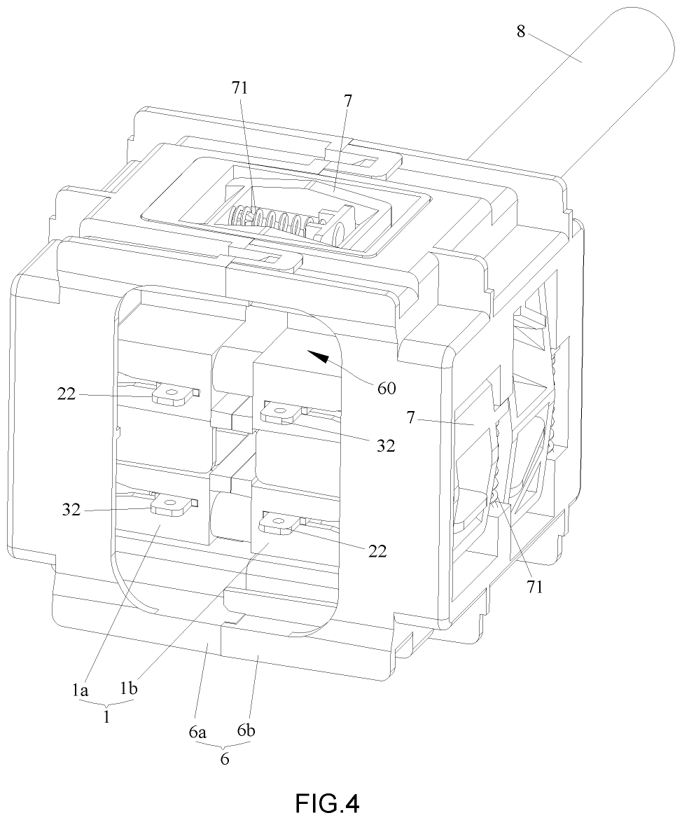

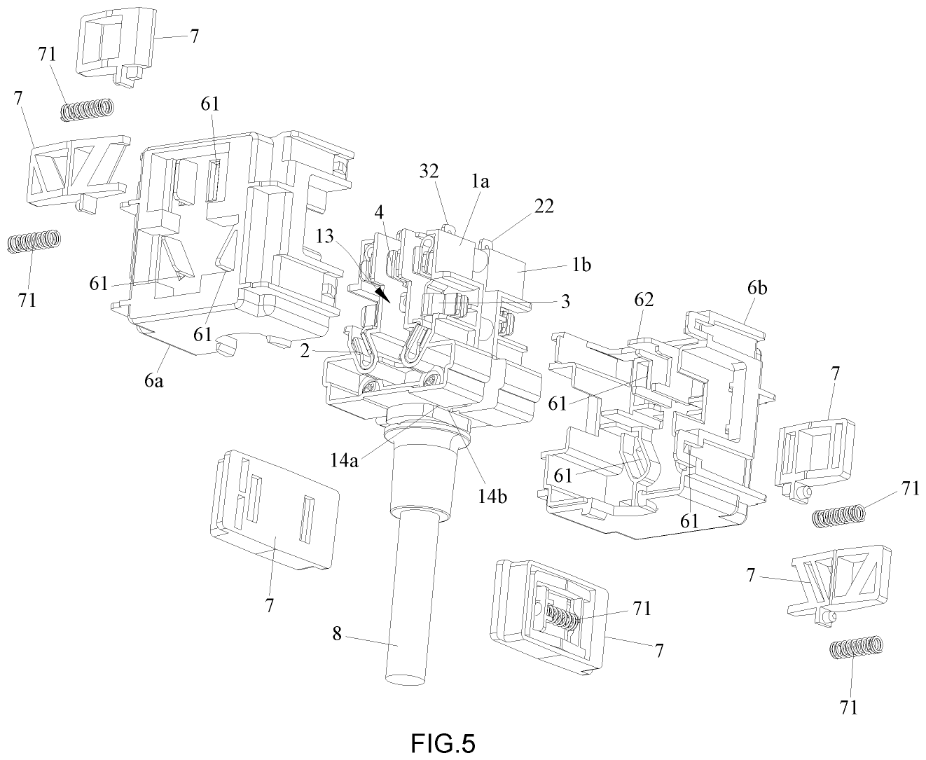

In the embodiments of the present utility model, as shown from FIG. 1 to FIG. 5, the multi-position change-over device can be installed in the housing of the multi-side socket (not shown) and can be electrically connected with the power supply; it comprises a plurality of core frames (1), wherein a core frame (1) is generally made from insulating material (such as plastic); each of at least three sides of the core frame (1) is arranged with a first slot (110) and a second slot (120) which are paired; the first slots (110) located on two adjacent sides are intersected to form the first mounting grooves (11), inside every first mounting groove (11) is installed with a first conducting sheet (2) and the said first conducting sheet (2) is arranged with a first conducting part (21) which is located in the first slots (110) [wherein the first slots (110) here refer to all the first slots (110) in the same first mounting groove (11)]; the second slots (120) located on two adjacent sides are intersected to form the second mounting grooves (12), inside every second mounting groove (12) is installed with a second conducting sheet (3) and the said second conducting sheet (3) is arranged with a second conducting part (31) which is located in the second slots (120) [wherein the second slots (120) here refer to all the second slots (120) in the same second mounting groove (12)]. After the corresponding pins (not shown) of the plugs (not shown) of the electronic and electrical products are inserted into the first slots (110) and the second slots (120), they respectively butt the corresponding first conducting part (21) and the corresponding second conducting part (31) to achieve electrical connection.

In the present utility model, each of at least three sides of a core frame (1) are arranged with a first slot (110) and a second slot (120) which are paired; meanwhile, the first slots (110) located on two adjacent sides are intersected to form the first mounting grooves (11) used for installing a first conducting sheet (2) and the second slots (120) located on two adjacent sides are intersected to form the second mounting grooves (12) used for installing a second conducting sheet (3) so that the first slots (110) located on two adjacent sides share one first conducting sheet (2) and the second slots located on two adjacent sides share one second conducting sheet (3) in order to make the core frame (1) smaller, save the consumption of the first conducting sheet (2) and the second conducting sheet (3) and improve the assembly efficiency and thus make the whole multi-side socket smaller, more exquisite, easier to carry and cost-lower. In addition, in the present utility model, the sharing design of the core frame and the conducting sheets reduces the number of the wiring positions, simplifies the internal wiring of the multi-side socket and improve the use safety of the multi-side socket.

Understandably, the selection of at least three sides of the core frame (1) to be arranged with a first slot (110) and a second slot (120) respectively depends on the actual use needs; for example, three sides arranged with the first slots (110) and the second slots (120) are not opposite to each other or at least two sides arranged with the first slots (110) and the second slots (120) are opposite to each other. In a preferred embodiment, the first slots (110) and the second slots (120) are arranged on two opposite sides and at least one side adjacent to the two opposite sides. That is, when three sides are arranged with the first slots (110) and the second slots (120), two opposite sides and one side adjacent to the said two opposite sides will be arranged with the first slots (110) and the second slots (120). That is, when four sides are arranged with the first slots (110) and the second slots (120), two opposite sides will be arranged with the first slots (110) and the second slots (120).

Concretely, the said first slots (110) are arranged at the positions where two adjacent sides of the core frame (1) approach their transition (or approach the corners of two adjacent sides); similarly, the second slots (120) are arranged at the positions where two adjacent sides of the core frame (1) approach their transition. Such arrange aims to reduce the space between the first slots (110) on two adjacent sides and between the second slots (120) on two sides and thus reduce the volumes of the core frames (1), the first conducting sheets (2) and the second conducting sheets (3) and ensure to further reduce the volume of the multi-side socket.

Further, the first conducting sheet (2) and the second conducting sheet (3) are arranged with conducting extension parts (22, 32) extending towards the common side of the core frame (1) [preferably to the side of the core frame (1) not arranged with the first slots (110) and the second slots (120)]; a circuit board (5) is arranged on the side of the core frame (1) for the conducting extension parts (22, 32) to extend out and the circuit board (5) is electrically connected with the conducting extension parts (22, 32).

In one embodiment of the present utility model, the circuit board (5) is provided with jacks (51, 52) corresponding to the conducting extension parts (22, 32), the input ends of the circuit board (5) is arranged at the jacks (51, 52), the jacks (51, 52) are sleeved with the conducting extension parts (22, 32) to electrically connect the said input ends with the conducting extension parts (22, 32), the edge of the said circuit board (5) is arranged with connecting apertures (53, 54) at the positions adjacent to the jacks (51, 52) and the output ends of the circuit board (5) is arranged at the connecting apertures (53, 54). The connecting apertures (53, 54) are used to externally connect other modules such as USB charging module in the multi-side socket that need power supply to supply power to other modules in the multi-side socket that need power supply after the first conducting sheet (2) and the second conducting sheet (3) are powered on; in addition, the circuit board (5) utilizes the inserting connection of the conducting extension parts (22, 32) with the jacks (51, 52) to replace the traditional soldering connection and thus facilitate the disassembly and assembly, improve the assembly efficiency and lower the costs.

In the embodiments of the present utility model, the core frame (1) comprises the first frame (1a) and the second frame (1b) which are arranged oppositely, wherein the first frame (1a) and the second frame (1b) are detachably connected or welded by ultrasonic wave.

Concretely, the said first frame (1a) is arranged with a positioning sleeve (15) extending towards the second frame (1b), the said second frame (1b) is arranged with a positioning column (16) which matches the positioning sleeve (15) and can be inserted into the positioning sleeve (15) in order to position the first frame (1a) and the second frame (1b) as well as increase their connection strength; in addition, the opposite sides of the first frame (1a) and the second frame (1b) as well as the positioning sleeve (15) jointly form a collision avoidance area (not marked) for the power cord to enter.

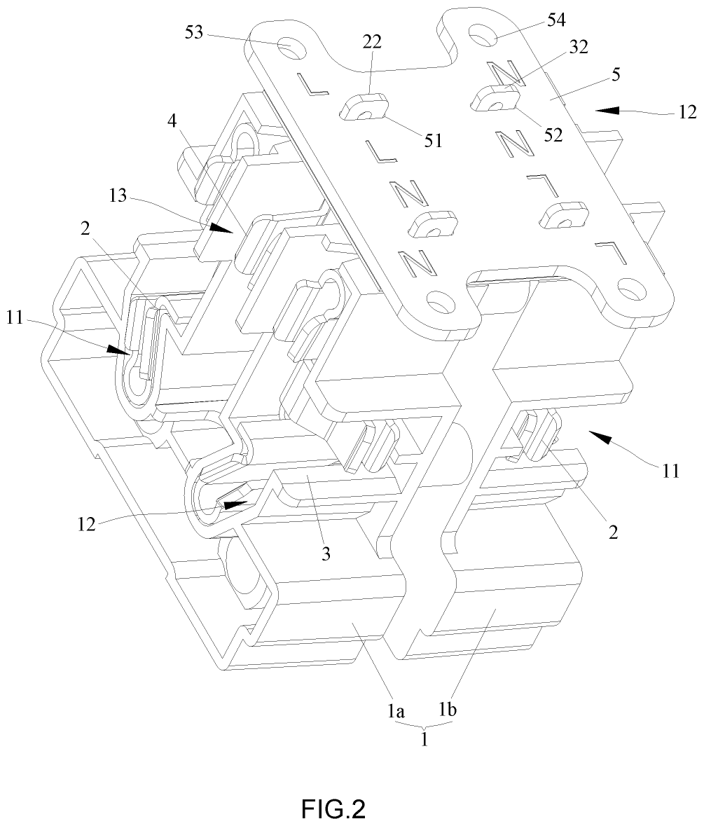

Understandably, when the core frame (1) comprises a first frame (1a) and a second frame (1b) which are connected, the arrangement of the first slots (110) and the second slots (120) on the first frame (1a) and the second frame (1b) depends on the actual use needs; for example, at least one of opposite sides of the first frame (1a) and the second frame (1b) are simultaneously arranged with the first slots (110) and the second slots (120). As shown in FIG. 1 and FIG. 2, both two opposite sides of the first slots (110) and the second slots (120) are arranged with the first slots (110) and the second slots (120).

Understandably, the above embodiments are the embodiments of a two-pole multi-position change-over device; in the process of use, one of the first conducting sheet (2) and the second conducting sheet (3) is used as the live-wire conducting sheet, and the other one is used as the null-wire conducting sheet; as for which one is used as the live-wire conducting sheet, it depends on which one is connected with the live wire of the power supply.

The plugs of electronic and electrical products can be divided into two-pin plugs or three-pin plugs; therefore, in order to match the three-pin plugs of electronic and electrical products, in another embodiment of the present utility model, at least one side of the core frame (1) may be arranged with a third slot (13) which matches the first slot (110) and the second slot (120) on such side, wherein the said third slot (13) is a blind slot or a through slot, inside the third slot (13) is installed with a third conducting sheet (4), and the said third conducting sheet (4) is arranged with a third conducting part (41) which matches the first conducting part (21) and the second conducting part (31) on the same side.

Concretely, the said third slot (13) is a through slot, and the third conducting sheet (4) is arranged with a third conducting part (41) which matches the first conducting part (21) and the second conducting part (31) located on at least two sides. Preferably, the third conducting sheet (4) is arranged with a third conducting part (41) which matches the first conducting part (21) and the second conducting part (31) located on two opposite sides.

Concretely, the said third conducting sheet (4) is fixed in the third slot (13) via a buckle structure or via a screw.

The present utility model also provides a multi-side socket, as shown in FIG. 1 to FIG. 5.

The multi-side socket comprises a housing (not shown) and a multi-position change-over device, wherein the structure of the said multi-position change-over device is seen in the embodiments described above, the said housing is arranged with corresponding pin through apertures (not shown) for the pins of the plugs of electronic and electrical products to pass through, and be finally inserted into the corresponding slots, and be electrically connected with the corresponding conducting parts. The multi-side socket adopts all the technical solutions of all embodiments of the multi-position conversion device described above. Therefore, it at least possesses all the beneficial effects arising from the technical solutions of the embodiments described above, and the beneficial effects are not repeated one by one here. It should be noted that when the plug of an electronic or electrical product is a two-pin plug, the slots described above include the first slot (110) and the second slot (120), and the conducting parts include the first conducting part (21) and the second conducting part (31); when the plug of an electronic or electrical product is a three-pin plug, the said slots described above include the first slot (110), the second slot (120) and the third slot (13), and the conducting parts include the first conducting part (21), the second conducting part (31) and the third conducting part (41).

In the embodiments of the present utility model, the multi-side socket also comprises a protective frame (6) located in the housing, wherein the said protective frame (6) defines the holding space (60) for holding the multi-position change-over device, the position of the protective frame (6) corresponding to the pin through apertures is arranged with corresponding pin guide apertures (61), and the said pin guide apertures (61) can be used for the pins of the plugs of electronic and electrical products to pass through. The protective frame can protect the core frame (1) and limit the first conducting sheet (2), the second conducting sheet (3) and the third conducting sheet (4) to prevent the first conducting sheet (2), the second conducting sheet (3) and the third conducting sheet (4) from loosening or coming out of the first mounting groove (11), the second mounting groove (12) and the third slot (13) respectively.

Concretely, the said protective frame (6) comprises a first slot frame (6a) and a second slot frame (6b) which are arranged oppositely, wherein the first slot frame (6a) and the second slot frame (6b) are open on opposite sides and butt to form the holding space (60). After the first slot frame (6a) and the second slot frame (6b) are butted, they can be limited directly through the inner wall of the housing (not shown) to prevent the first slot frame (6a) and the second slot frame (6b) from loosening or separating; however, in order to increase the connection strength between the first slot frame (6a) and the second slot frame (6b), the first slot frame (6a) and the second slot frame (6b) can also be fixedly connected by screws, buckles, ultrasonic welding, hot riveting or tight fitting or other technologies.

In the embodiments of the present utility model, the holding space (60) formed by the first slot frame (6a) and the second slot frame (6b) matches the core frame (1), wherein the first slot frame (6a) and the second slot frame (6b) are movably sleeved on the periphery of the core frame (1), and the first slot frame (6a) and the second slot frame (6b) are arranged with a limit part (62) extending towards the interior of the core frame (1), and the core frame (1) is arranged with a limit groove for the limit part (62) to extend into in order to guide the installation of the protective frame (6) and increase the connection strength between the protective frame (6) and the core frame (1). The limit groove can be arranged separately, or the third slot (13) can be used as a limit groove at the same time, that is, sharing one slot; when the limit groove and the third slot (13) share one slot, the limit part (62) will be in the shape of an enclosing board, which can be sleeved onto the third conducting part (41) to limit the third conducting part.

Understandably, the first conducting sheet (2) and the second conducting sheet (3) or the first conducting sheet (2), the second conducting sheet (3) and the third conducting sheet (4) generally need to be electrically connected with the power supply through a pin or power cord; when they are electrically connected with the power supply through a pin, one end of the pin is inserted into the core frame (1) and is connected respectively with the corresponding first conducting sheet (2) and the corresponding second conducting sheet (3) or with the corresponding first conducting sheet (2), the corresponding second conducting sheet (3) and the corresponding third conducting sheet (4), the other end of the pin extends out of the housing.

When they are electrically connected with the power supply through a power cord (8), one end of the said power cord (8) successively passes through the housing and the protective frame (6) and then extends into the core frame (1), and then is electrically connected with the first conducting sheet (2) and the second conducting sheet (3), or with the first conducting sheet (2), the second conducting sheet (3) and the third conducting sheet (4), and the said core frame (1) clamps and fixes the power cord. Concretely, the said core frame (1) comprises a first frame (1a) and a second frame (1b); the side of the first frame (1a) and the second frame (1b) where the power cord enters is arranged with a first positioning part (14a) and a second positioning part (14b) which are arranged oppositely; the said first positioning part (14a) and the second positioning part (14b) form a clamping aperture; the said guide wire (8) passes through the clamping aperture and then is clamped between the first positioning part (14a) and the second positioning part (14b).

Further, the interior of the housing (not shown) is also arranged with a USB charging module (not shown) which is electrically connected with the first conducting sheet (2) and the second conducting sheet (3) directly or through the circuit board (5); the housing is arranged with a USB jack (not shown) to plug in the charging socket of the USB charging module and thus increase the functions of the change-over socket.

Further, the positions of the protective frame (6) corresponding to the pin guide apertures (61) are installed with a safety door (7) and a reset spring (71), wherein the safety door (7) can move between the positions of closing and starting the pin guide apertures (61), and the reset spring (71) is used to apply a resilient force on the safety door (7) in order to move towards the position of closing the pin guide apertures (61). When the plug of an electronic or electrical product is plugged in, the safety door (7) will overcome the resilient force of the reset spring (71) and move to the position where the pin guide apertures (61) are opened under the impelling force of the pins of the plug of the electronic or electrical product (such as the live-wire pin and the null-wire pin, or the live-wire pin, the null-wire pin and the ground-wire pin, not shown); when the plug of the electronic or electrical product is pulled out, the safety door will close the pin guide apertures (61) again under the resilient force of the reset spring (71) to play the role in dust prevention and safety protection. It can be understood that there are multiple ways of installing the safety door (7) and the reset spring (71); for example, one way is to set sliding slots on outer sides of the protective frame (6) (not shown in the drawings), install the safety door (7) in a sliding manner into the sliding slots and one end of the reset spring (71) is propped against the safety door (7) and the other end is propped against the protective frame (6). The specific arrangement of the safety door (7) and the reset spring (71) is not described in detail here because there are a plurality of embodiments in the prior art.

The embodiments described above are merely the preferred embodiments of the present utility model, not to limit the patent scope of the present utility model; with the conception of the present utility model, any equivalent structure transformation using the Specifications and the accompanying drawings of the present utility model or direct/indirect applications to other related technical fields should be included in the scope claimed by the present utility model.

What is claimed is:

1. A multi-position change-over apparatus, which is characterized in that it comprises a plurality of core frames, wherein each of at least three sides of the said core frame is arranged with a first slot and a second slot which are paired, the first slots located on two adjacent sides are intersected to form the first mounting groove and inside each first mounting groove is installed with a first conducting sheet and the said first conducting sheet is provided with a first conducting part located in the first slot; the second slots located on two adjacent are intersected to form the second mounting groove and inside each second mounting groove is installed with a second conducting sheet and the said second conducting sheet is provided with a second conducting part located in the second slot.

2. The multi-position change-over device in accordance with claim 1, which is characterized in that the first slots and the second slots are arranged on two opposite sides and at least one side adjacent to the two opposite sides.

3. The multi-position change-over device in accordance with claim 2, which is characterized in that two groups of two opposite sides are arranged with the first slots and the second slots.

4. The multi-position change-over device in accordance with claim 1, which is characterized in that the said first slots are arranged where two adjacent sides approach the transition between them and the said second slots are arranged where two adjacent sides approach the transition between them.

5. The multi-position change-over device in accordance with claim 1, which is characterized in that the said first conducting sheet and the said second conducting sheet are provided with a conducting extension part respectively extending to the common side of the core frame, the side of the core frame for the conducting extension parts to extend is arranged with a circuit board and the said circuit board is electrically connected with the conducting extension parts.

6. The multi-position change-over device in accordance with claim 5, which is characterized in that the circuit board is provided with jacks corresponding to the conducting extension parts, the input ends of the circuit board is arranged at the jacks, the jacks are sleeved with the conducting extension parts to electrically connect the said input ends with the conducting extension parts, the edge of the said circuit board is arranged with connecting apertures at the positions adjacent to the jacks and the output ends of the circuit board is arranged at the connecting apertures.

7. The multi-position change-over device in accordance with claim 1, which is characterized in that the said core frame comprises a first frame and a second frame which are arranged oppositely, wherein the first frame and the second frame are detachably connected.

8. The multi-position change-over device in accordance with claim 7, which is characterized in that at least one of the opposite sides of the said first frame and the said second frame is simultaneously arranged with a first slot and a second slot.

9. The multi-position change-over device in accordance with claim 7, which is characterized in that the said first frame is arranged with a positioning sleeve extending in the direction of the second frame and the said second frame is arranged with a positioning column which matches the positioning sleeve and can be inserted into the positioning sleeve.

10. The multi-position change-over device in accordance with claim 9, which is characterized in that at least one side of the core frame is arranged with a third slot pairing the first slot and the second slot on the core frame, a third conducting sheet is installed in the said third conducting sheet, and the third conducting sheet is arranged with a third conducting part matching the first conducting part and the second conducting part on the same side.

11. The multi-position change-over device in accordance with claim 10, which is characterized in that the said third slot is a through slot, and the third conducting sheet is arranged with a third conducting part which matches the first conducting part and the second conducting part located on both sides.

12. A multi-side socket, which is characterized in that it comprises a housing and a multi-position change-over device in accordance with claim 11, wherein the said housing is arranged with corresponding pin through apertures.

13. The multi-side socket in accordance with claim 12, which is characterized in that it also comprises a protective frame located in the housing, wherein the said protective frame defines the holding space for holding the multi-position change-over device, the position of the protective frame corresponding to the pin through apertures is arranged with corresponding pin guide apertures, and the said pin guide apertures can be used for the pins of the plugs of electronic and electrical products to pass through.

14. The multi-side socket in accordance with claim 13, which is characterized in that the said protective frame comprises a first slot frame and a second slot frame which are arranged oppositely, wherein the first slot frame and the second slot frame are open on both opposite sides and butt to form the holding space.

15. The multi-side socket in accordance with claim 14, which is characterized in that the said first slot frame and the said second slot frame are movably sleeved at the periphery of the core frame, and that the said first slot frame and the said second slot are arranged with a limit part respectively extending towards the interior of the core frame, and the core frame is arranged with a limit groove for the limit parts to extend into.

16. The multi-side socket in accordance with claim 14, which is characterized in that it also comprises a power cord for connecting the power supply, wherein the said power cord successively passes through the housing and the protective frame, and then extends into the core frame, and then is electrically connected with the first conducting sheet and the second conducting sheet or with the first conducting sheet, the second conducting sheet and the third conducting sheet, and the said core frame fixes the power cord clamp.

17. The multi-side socket in accordance with claim 16, which is characterized in that the said core frame comprises a first frame and a second frame; the side of the first frame and the second frame where the power cord enters is arranged with a first positioning part and a second positioning part which are arranged oppositely; the said first positioning part and the second positioning part form a clamping aperture; the said guide wire passes through the clamping aperture and then is clamped between the first positioning part and the second positioning part.

18. The multi-side socket in accordance with claim 12, which is characterized in that inside the housing is also arranged with a USB charging module which is electrically connected with the first conducting sheet and the second conducting sheet directly or via the circuit board, and the housing is arranged with a USB jack.

19. The multi-side socket in accordance with claim 12, which is characterized in that the positions of the protective frame corresponding to the pin guide apertures are installed with a safety door and a reset spring, wherein the safety door can move between the positions of closing and starting the pin guide apertures, and the reset spring is used to apply a resilient force on the safety door in order to move towards the position of closing the pin guide apertures.
